(19) United States
(12) Patent Application Publication
(10) Pub. No.: US 2005/0013935 A1
(43) Pub. Date: Jan. 20, 2005

(54) Pattern-arranged carbon nano material structure and manufacturing method thereof

(75) Inventors: Sumio Iijima, Aichi (JP); Zhu Jin, Ibaraki (JP); Zhang Minfang, Ibaraki (JP); Masako Yudasaka, Ibaraki (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/892,484

(22) Filed: Jul. 16, 2004

(30) Foreign Application Priority Data
Jul. 17, 2003 (JP) 2003-276335

(51) Int. Cl. B05D 3/02

(52) U.S. Cl. 427/228; 427/256; 428/408

(57) ABSTRACT

The object of the present invention is to provide a pattern-arranged carbon nano material structure applicable of evaluation of properties of materials and a variety of application such as field emission display, gas storage, biological recognition, drug delivery and the like, and a manufacturing method thereof. The structure is constituted so that carbon nano material is secured to aromatic polycyclic molecule fixed on a substrate surface and cation with a graphite structure in a single layer and also in a specific pattern arrangement.

### BACKGROUND OF THE INVENTION

1. Field of the Invention

The present invention relates to a pattern-arranged carbon nano material structure and a manufacturing method thereof. More specifically, the present invention relates to a pattern-arranged carbon nano material structure applicable to evaluation of properties of the materials and a variety of application and a manufacturing method thereof.

All of patents, patent applications, patent publications, scientific articles and the like, which will hereinafter be cited or identified in the present application, will, hereby, be incorporated by references in their entirety in order to describe more fully the state of the art, to which the present invention pertains.

2. Description of the Related Art

Nano structures including a carbon nanotube have been drawing attention as an area of developing a new nano-technology field and application thereof such as an electric device, sensor, fuel cell and the like have been highly attractive. Deployment of technology of single wall carbon nanohorns (SWNHs) and single wall carbon nanotube (SWNT) is allowed by inventors of the present invention to play a leading role in such a nano-technology (Japanese Laid-Open Patent Publication 2002-159851 and 2002-154813).

### SUMMARY OF THE INVENTION

With development of nano-technology, structures of nanometer-scale materials pattern-arranged on the surface of solid have been holding the important key to investigation of basic properties of the nanometer-scale materials and to application of the nanometer-scale materials. Particularly, carbon nano material including a single wall carbon nanotube and single wall carbon nanohorns applicable to a variety of application such as field emission display, gas storage, biological recognition, drug delivery and the like becomes a target.

However, technique of fixing the carbon nano material on the solid surface has not been found. Therefore, such a technique has been strongly desired.

The present invention has been carried out in consideration the above-mentioned circumstance. An object of the present invention is to provide a pattern-arranged carbon nano material structure and a manufacturing method thereof, which overcomes the problems of prior art and which is applicable to evaluation of properties of materials and a variety of application.

The present invention firstly provides, as a means to solve the above-mentioned problems, a pattern-arranged carbon nano material structure characterized in that carbon nano material is fixed in a single layer and also in a specific pattern arrangement, that is a quasi-single layer, on aromatic polycyclic molecule secured to a substrate or cation with a graphite structure.

The present invention secondly provides a pattern-arranged carbon nano material structure in the first invention, characterized in that the carbon nano material fixed on the aromatic polycyclic molecule or the cation with the graphite structure is a single wall carbon nanohorns or a single wall carbon nanotube. The present invention thirdly provides a pattern-arranged carbon nano material structure characterized in that the aromatic polycyclic molecule is naphthalene, anthracene, or pyrene which may have substituents.

The present invention fourthly provides a pattern-arranged carbon nano material structure characterized in that the substrate is a solid having a surface of oxide or a solid capable of forming hydroxyl group on the surface.

The present invention fifthly provides a pattern-arranged carbon nano material structure characterized in that the carbon nano material is fixed on the substrate in a single layer and also in a specific pattern arrangement. The present invention sixthly provides a pattern-arranged carbon nano material structure characterized in that the carbon nano material is a single wall carbon nanohorns (SWNHs) or a single wall carbon nanotube (SWNT).

The present invention seventhly provides a manufacturing method for the pattern-arranged carbon nano material structure characterized in that the carbon nano material is fixed in a single layer and also in a specific pattern arrangement on aromatic polycyclic molecule secured to a substrate in a specific pattern arrangement or cation with a graphite structure. The present invention eighthly provides a manufacturing method for the pattern-arranged carbon nano material structure characterized in that hydroxyl group terminating a substrate surface is reacted with aminosilane bifunctional molecule to coat an oxide surface with amino group, subsequently reacted with succineimide ester aromatic polycyclic molecule body to secure the aromatic polycyclic molecule, and further securing the carbon nano material to the aromatic polycyclic molecule in a single layer and also in a specific pattern arrangement.

The present invention ninthly provides a manufacturing method for the pattern-arranged carbon nano material structure characterized in that the carbon nano material is a single wall carbon nanohorns (SWNHs) or a single wall carbon nanotube (SWNT) in the seventh or eighth invention.

The present invention tenthly provides a manufacturing method for the pattern-arranged carbon nano material structure, comprising: heating the structure produced in any method above-described to decompose organic molecule, producing the structure in which carbon nano material is fixed on the substrate in a single wall and also in a specific pattern arrangement.

As described above in detail, the present invention provides a pattern-arranged carbon nano material structure applicable to evaluation of properties of materials and a variety of application such as field emission display, gas storage, biological recognition, drug delivery and the like.

### BRIEF DESCRIPTION OF DRAWINGS

FIG. 1 is a view showing an example of processes of a manufacturing method for a pattern-arranged carbon nano material structure according to the present invention.

FIG. 2 is an SEM picture showing an embodiment of a pattern-arranged carbon nano material structure (SWNHs) according to the present invention.

FIG. 3 is an SEM picture showing other embodiment of a pattern-arranged carbon nano material structure (SWNHs) according to the present invention.

FIG. 4 is an SEM picture showing further other embodiment of a pattern-arranged carbon nano material structure (SWNHs) according to the present invention.

FIG. 5 is an SEM picture showing further other embodiment of a pattern-arranged carbon nano material structure (SWNT) according to the present invention.

FIG. 6 is a view showing a Raman spectrum of a pattern-arranged carbon nano material structure (SWNT) of FIG. 5.

### BEST MODES FOR CARRYING OUT THE INVENTION

A pattern-arranged carbon nano material structure according to the present invention features that carbon nano material is fixed in a single layer and also in a specific pattern arrangement, that is a quasi-single layer, on aromatic polycyclic molecule secured to surface of a substrate or cation with a graphite structure. Fixation of the carbon nano material in this case, is achieved by a π-π interaction with the aromatic polycyclic molecule, or by strong fixing force due to cation-π interaction with a cation molecule with the graphite structure.

In the present invention, condensed ring type molecule and non-condensed type molecule such as naphthalene, anthracene, phenanthrene, pyrene and the like, and heterocyclic ring type molecule such as quinoline are considered as the aromatic polycyclic molecule. Particularly, the condensed ring type molecule is preferable. These aromatic polycyclic molecule may also properly have substituents such as alkyl group, alkenyl group, alkoxy group, ester group, and nitro group permissively.

In the present invention, cation molecule with various graphite structures may be taken into consideration. For instance, imidazolium tetrafluoroborate and the like is listed as an example.

As described above, the pattern-arranged carbon nano material structure is fixed in a single layer and also in a specific pattern arrangement, that is a quasi-single layer, therefore basic properties of the carbon nano material fixed on the solid surface can be easily measured and analyzed, and a single wall carbon nanohorns (SWNHs) or a single wall carbon nanotube (SWNT) is preferably used, which can be expected for application for a variety of fields such as field emission display, gas storage, biological recognition, drug delivery and the like as the carbon nano material fixed on aromatic polycyclic molecule or cation with a graphite structure.

The pattern-arranged carbon nano material structure according to the present invention can be produced using various methods. A contact reaction of the aromatic polycyclic molecule secured to the substrate in a specific pattern arrangement or cation with a graphite structure and the carbon nano material may be carried out.

Specifically, such a method is realized through various procedures and processes. The method features that, for instance, hydroxyl group terminating a substrate surface is reacted with an aminosilane bifunctional molecule to coat a surface of solid oxide with amino group, subsequently the amino group is reacted with succineimide ester aromatic polycyclic molecule body to pattern and secure the aromatic polycyclic molecule, and further a carbon nano material is secured to the aromatic polycyclic molecule in a single layer and also in a specific pattern arrangement, that is a quasi-single layer. The use of the above-described method enables easy manufacturing of a high-quality pattern-arranged carbon nano material structure.

A variety of materials may be used as carbon nano materials, particularly, a single wall carbon nanohorns (SWNHs) or a single wall carbon nanotube (SWNT) may be preferably used. As to these carbon nano materials, in order to improve dispersion into water, a previous oxidation treatment may be performed to give affinity to water. This oxidation treatment may be performed, for instance, in the case of a single wall carbon nanohorns (SWNHs), by using oxygen gas at a temperature in a range from 400° C. to 450° C. and at an atmospheric pressure. The carbon nano material is subjected to supersonic treatment and subsequent centrifugation and the clear supernatant liquid is filtrated to obtain a sufficiently dispersed carbon nano material. Further using the carbon nano material enables easy manufacturing of superior pattern-arranged carbon nano material structure.

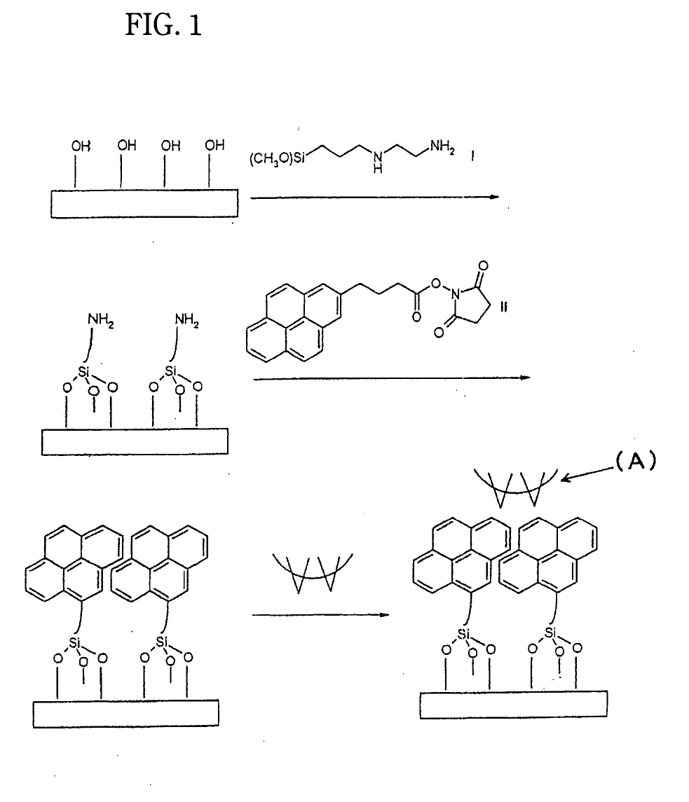

FIG. 1 is a patternized reaction process diagram showing a manufacturing method for a pattern-arranged carbon nano material structure according to the present invention.

As shown in FIG. 1 for example, an aminosilane bifunctional molecule is firstly reacted with hydroxyl group terminating a substrate surface to form a coated surface with amino group. Subsequently, the amino group on the surface is reacted with succineimide ester pyrenes and the like to, for instance, form a layer terminated by pyrene. Further, the carbon nano material (A) such as a single wall carbon nanohorns or a single wall carbon nanotube is secured to, for instance, the pyrene in a single layer and also in a specific pattern arrangement to manufacture the pattern-arranged carbon nano material structure.

Fixation of the carbon nano material onto aromatic polycyclic molecule such as pyrene in a quasi-single layer as above-described is due to a strong π-π interaction thereof.

A substrate in the present invention may be a variety of solid which easily immobilize aromatic polycyclic molecule and cation molecule with a graphite structure.

Particularly, a solid having an oxide wall on its surface and a solid capable of forming hydroxyl group on the surface are considered to be preferable. As solid oxide, a variety of inorganic oxides such as SiO₂, SnO₂, TiO₂, and ITO or a variety of organic complex oxides and the like may be considered. As to these oxides, for instance, a portion of the oxide may be previously patternized through a patterning of surface oxide due to thermal oxidation of Si substrate.

As positions of the aromatic polycyclic molecule such as fixed pyrene is patternized, the patternized arrangement of the carbon nano material in the quasi-single layer is easily achieved. That is, only reactions of FIG. 1 needs to be controlled.

According to the present invention, aromatic polycyclic molecule and cation molecule with a graphite structure is subjected to heat treatment to decompose organic molecule constituting the same, and resulting in providing a structure securing the carbon nano material to the substrate in a single layer and also in a specific pattern arrangement. Production of new bindings due to decomposition of the organic molecule is taken into account.

A quasi-single layer SWNH etc. is used for field emission display, and that is useful in nano tribology and for cell adhesion and biological recognition. An optical bandgap structure arranged in a beehive shape is also formed. Gas absorption on SWNH etc. can vary dielectric coefficient in solvent, and become possible to be used as a gas sensing with high selectivity and sensitivity.

SWNH is also secured to carbon fiber and glass fiber, therefore sheet type solvent is expected to be used for filtration of chemical reagent of gas or solution.

A single layer structure of SWNH formed on material as described above may be used for chromatography for biological separation of DNA, protein, or conventional polymer etc. A biological analytic view is also conceived by detected DNA strand attached onto pyrene. A confocal microscope or flat-screen scanner of the detected DNA strand may be used for forming a Raman signal or a path of black spot of SWNH on the surface due to assembly of SWNH.

Examples are shown with reference to the accompanying drawings below, and embodiments of the present invention is described in more detail. Of course, the present invention is not limited to following examples and it goes without saying that various embodiments of details is possible.

### EXAMPLE 1

A solid oxide surface having an SiO₂ surface due to thermal oxidation of Si and a solid oxide surface having a thin film of ITO (indium tin oxide) were prepared.

To each surface, reaction was performed in accordance with a reaction formula in FIG. 1 to secure pyrene. Steps of procedures in this case is explained as follows when describing, for instance, a case of SiO₂ surface as an example.
1) At first, a substrate of SiO₂ surface was dipped into a solution of HCl:CH₃OH (1:1 by volume, for 30 minutes), and then dipped into sulfuric acid for 30 minutes, followed by boiling in H₂O for 5 minutes to maximize existence of surface OH-group (hydroxyl group).
2) Then, the substrate was dipped into a solution of aminosilane molecule (I) (1% of 1 mM of acetic acid aqueous solution) in FIG. 1 for 20 minutes, followed by annealing with placed on a hot plate at a temperature of 120° C. for 4 minutes.
3) The substrate after annealing was subjected to a contact reaction with a mixed solution which was prepared by adding 1 mg of pyrene molecule (II) of FIG. 1 to a mixture of 500 μl of sodium tetraborate buffer solution (0.1 M, pH8.5) and 400 μL of DMF.

Thereby, oxide surface patternized and fixed with the pyrene was achieved.

For a quasi-single layer structure of SWNHs onto solid oxide surface, dispersion of aqueous solution of SWNH is important, therefore oxidation-treated SWNHs was subjected to supersonic treatment in H₂O for 1 hour, followed by centrifugal separation at 10 krpm for 5 minutes to filtrate the clean supernatant liquid with 0.45 μm of a glass filter. After these processes, dispersion of SWNHs was relatively stable.

The oxide patternized due to fixation of pyrene was immersed into the dispersion liquid to form a pattern-arranged SWNHs structure of a quasi-single layer on the oxide surface.

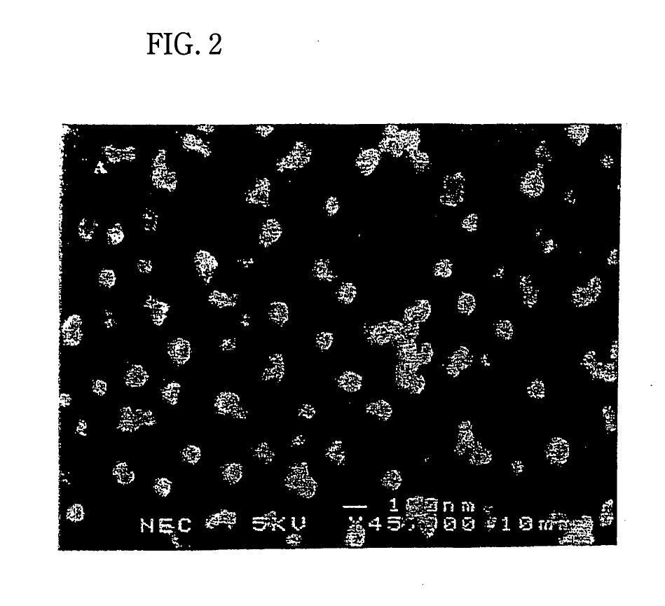

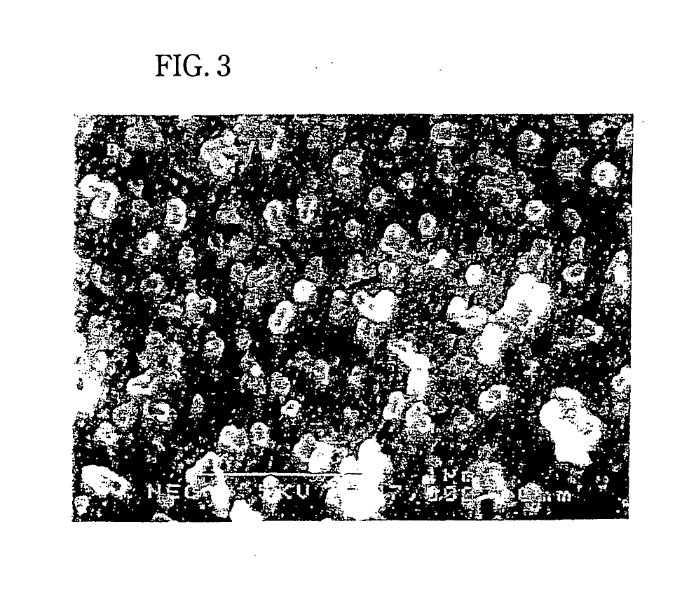

The pattern-arranged SWNHs structure of the quasi-single layer are shown in FIGS. 2 and 3. FIG. 2 shows a pattern fixation of SWNHs on Si thermal oxidized surface (SiO₂ surface), and FIG. 3 shows a pattern fixation of SWNHs on a thin film surface of ITO (Indium Tin Oxide).

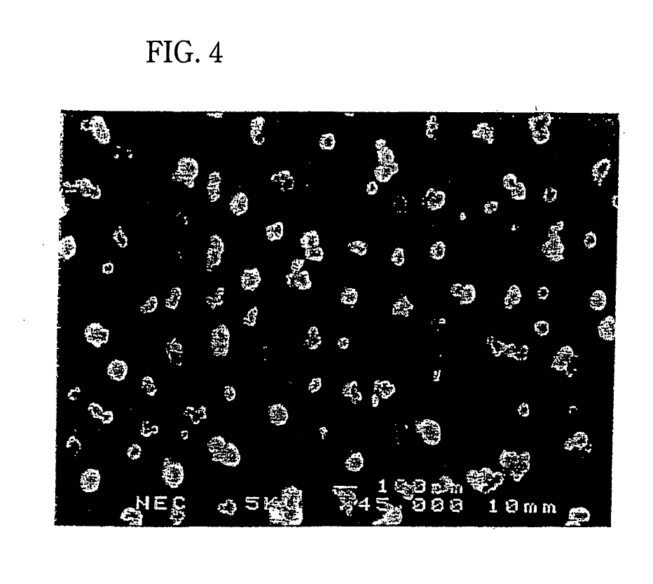

FIG. 4 is a picture showing the condition after heating in vacuum at a temperature of 1000° C. as to the SWNHs fixed on the SiO₂ surface. It is found that SWNHs is strongly fixed on SiO₂ surface.

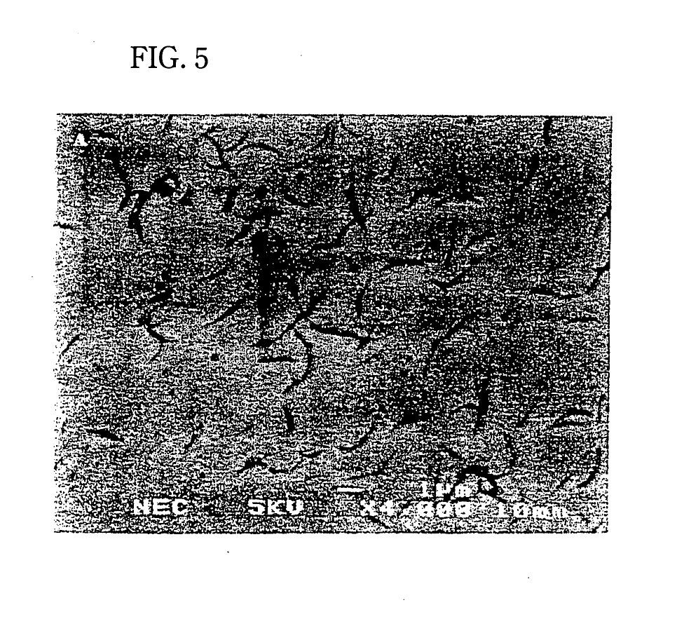

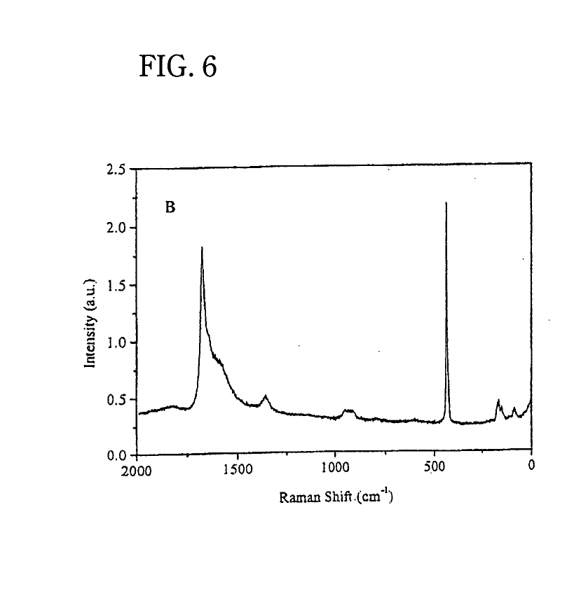

As nanometer-scale carbon materials except SWNHs capable of preferably using a manufacturing method for the pattern-arranged carbon nano material structure in the present invention, a single wall carbon nanotube (SWNT) is listed. A picture of FIG. 5 shows a condition of fixing SWNT of a quasi-single layer onto SiO₂ surface. FIG. 6 shows a Raman spectrum thereof.

1. A pattern-arranged carbon nano material structure, wherein carbon nano material is fixed onto aromatic polycyclic molecule secured to a substrate or cation with a graphite structure in a single layer and also in a specific pattern arrangement.

2. A pattern-arranged carbon nano material structure as claimed in claim 1, wherein carbon nano material fixed onto aromatic polycyclic molecule or cation with a graphite structure is single wall carbon nanohorns (SWNHs) or single wall carbon nanotube (SWNT).

3. A pattern-arranged carbon nano material structure as claimed in claim 1, wherein aromatic polycyclic molecule is naphthalene, anthracene, or pyrene which may have substituents.

4. A pattern-arranged carbon nano material structure as claimed in any one of claim 1, wherein a substrate is a solid having oxide surface or a solid capable of forming hydroxyl group on the surface.

5. A pattern-arranged carbon nano material structure, wherein carbon nano material is fixed onto a substrate in a single layer and also in a specific pattern arrangement.

6. A pattern-arranged carbon nano material structure as claimed in claim 5, wherein carbon nano material is single wall carbon nanohorns (SWNHs) or single wall carbon nanotube (SWNT).

7. A manufacturing method for the pattern-arranged carbon nano material structure, wherein carbon nano material is fixed onto aromatic polycyclic molecule secured to a substrate or cation with a graphite structure in a single layer and also in a specific pattern arrangement.

8. A manufacturing method for the pattern-arranged carbon nano material structure as claimed in claim 7, wherein hydroxyl group terminating a substrate surface is reacted with an aminosilane bifunctional molecule to coat oxide surface with amino group, subsequently reacted with succineimide ester aromatic polycyclic molecule body to secure the aromatic polycyclic molecule, and further the carbon nano material is fixed onto the aromatic polycyclic molecule in a single layer and also in a specific pattern arrangement.

9. A manufacturing method for the pattern-arranged carbon nano material structure as claimed in claim 7, wherein carbon nano material is single wall carbon nanohorns (SWNHs) or single wall carbon nanotube (SWNT).

10. A manufacturing method for the pattern-arranged carbon nano material structure, wherein the structure produced in the method as claimed in any one of claim 7 is heated to discompose organic molecule, thereby producing a structure in which the carbon nano material is fixed onto a substrate in a single layer and also in a specific pattern arrangement.

11. A pattern-arranged carbon nano material structure as claimed in claim 2, wherein aromatic polycyclic molecule is naphthalene, anthracene, or pyrene which may have substituents.

12. A manufacturing method for the pattern-arranged carbon nano material structure as claimed in claim 8, wherein carbon nano material is single wall carbon nanohorns (SWNHs) or single wall carbon nanotube (SWNT).
